(19) United States
(12) Patent Application Publication
(10) Pub. No.: US 2005/0261434 A1
(43) Pub. Date: Nov. 24, 2005

(54) Thermoplastic elastomeric blends having enhanced surface appearance

(76) Inventors: Piraye Yaras, Arlington, TX (US); Shannon Flora, Mansfield, TX (US)

Correspondence Address: WINSTON & STRAWN LLP, 1700 K STREET, N.W., WASHINGTON, DC, 20006, US

(21) Appl. No.: 10/851,324

(22) Filed: May 24, 2004

(51) Int. Cl. C08L 51/00

(52) U.S. Cl. 525/240

(57) ABSTRACT

Disclosed is a thermoplastic elastomer blend with reduced surface defects comprising a high flow, propylene-based resin, about 0.01 to 15 weight percent of a processability modifier component, and about 1 to 50 weight percent of an ethylene-based toughening component. The blend may also contain compatibilizers, additives, and mineral fillers.

### TECHNICAL FIELD

The present invention relates generally to thermoplastic elastomeric blends and particularly to blends including high flow propylene-based resins, an ethylene-based toughening component to increase the impact strength of the composition, and a processability modifier component to enhance surface appearance by minimizing or avoiding surface defects. Also included are molded articles with reduced surface defects formed from such blends, as well as methods for producing such blends and molded articles.

### BACKGROUND OF THE INVENTION

Thermoplastic elastomers (TPEs) are an important class of polymers that are particularly useful in producing durable components through injection molding processes. A typical TPE is a material that exhibits rubberlike characteristics, yet is melt processable with most thermoplastic processing equipment. The rubberlike characteristics typically desired include high extensibility, mechanical recovery, resiliency, and low temperature ductility.

Surface appearance of injection molded parts formed from thermoplastic elastomeric blends has become a quality criterion of prime importance, especially in consumer applications, such as in the electronic appliance and automotive-markets. Surface defects (e.g., flow marks or flow plumes) may not perceivably affect the mechanical properties of the molded article nor be discernible by touch; however, the presence of such defects gives the appearance of inhomogeneity within molded parts, reducing the aesthetic appeal and perceived quality of the finished product. The impact of defects on the appearance and perceived quality is more pronounced in parts with complex geometry, which typically require a higher melt flow rate TPE blend for optimum processability.

Flow marks typically appear on the surface of injected molded articles as a series of alternating high and low gloss chevrons. The general trend of each band is approximately perpendicular to the direction of melt flow during injection. Flow plumes, on the other hand, manifest on the surface of molded parts as meandering eddies that exhibit structural dynamics similar to tidal currents or volcanic gas clouds. The presence of flow plumes may be accompanied by delamination under the surface defect area. Reduction of surface defects on molded parts has been attempted in the prior art, and a few such attempts are described below.

Japanese patent publication No. 62-151437 describes a polypropylene resin composition obtained by blending a crystalline propylene homopolymer with a melt flow rate of 10 to 20 dg/min, a crystalline propylene-ethylene block copolymer with a melt flow rate of 30 to 80 dg/min and an amorphous ethylene-propylene copolymer with a 10 to 50 Mooney viscosity (ML 1+4, 100° C.).

U.S. Pat. No. 5,045,589 describes a polypropylene composition comprising a crystalline ethylene-propylene block copolymer having an ethylene content of 5-20 weight percent and a melt flow index of 11-90, a thermoplastic elastomer, an amorphous propylene-alpha-olefin random copolymer having a number average molecular weight of 1,000-20,000 and a propylene content of 40-95 weight percent, and an inorganic filler. The polypropylene composition, when made into large-sized molded articles, is stated to give no flow marks, no waviness, and no voids.

U.S. Pat. No. 5,468,808 demonstrates that the addition of a low molecular weight viscoelastic liquid rubber reduces the severity of flow marks on molded articles formed from a blend comprising propylene and a high molecular weight rubber. The low molecular weight rubber has a weight average molecular weight of less than about 40,000 and is liquid at room temperature.

Japanese patent publication No. 2000-154281 describes a polyolefin resin composition that improves surface appearance of a molded article, especially color nonuniformity, without detriment to the mechanical properties. The composition comprises a polyolefin resin having a7 density greater than or equal to 0.905 g/cm³, petroleum resin obtained by polymerizing an unsaturated C₆ to C₉ component produced in naphtha cracking, and filler selected from among calcium carbonate, precipitated barium sulfate, glass beads, and silica.

U.S. Pat. No. 6,245,856 describes a thermoplastic olefin composition comprising polypropylene, ethylene-alpha-olefin elastomer and a compatibilizer comprising an ethylene-propylene copolymer with a number average molecular weight of from 40,000 to 300,000, a molecular weight distribution of from 1.8 to 4.5, and a propylene content from 80 to 92 weight percent. Table III shows additional compatibilizer characteristics of a melting point of from 50° C. to 92° C. and a Mooney viscosity (ML 1+4, 125° C.) of from 19 to 33.

U.S. Pat. No. 6,465,572 describes a polymer composition to improve surface appearance of molded parts that comprises propylene block copolymer, impact modifier, filler, and ultrahigh molecular weight propylene homopolymer or random copolymer with a weight average molecular weight of at least 800,000. The molded article formed from this polymer composition exhibits surface defects, especially in the form of a stripe or wave pattern, to a strongly reduced extent.

Numerous methods have been attempted to decrease flow marks or flow plumes in thermoplastic elastomeric blends; however, these methods have proven to be insufficient in improving the appearance of the resultant article without sacrificing desirable physical properties, such as a satisfactory balance of stiffness and impact resistance. Thus, there exists a need to reduce the surface defects in articles produced from thermoplastic elastomeric blends without detrimentally affecting other physical properties, thereby enhancing the surface appearance of the molded article and, consequently, its commercial value.

### SUMMARY OF THE INVENTION

The invention encompasses a thermoplastic elastomeric composition including a high flow, propylene-based resin having a melt flow rate of at least about 20 dg/min, measured at 230° C. and 2.16 kg, present in an amount sufficient to increase a rigidity of the composition; an ethylene-based toughening component, with a weight average molecular weight of at least about 95,000 to 1,000,000 which is present in an amount sufficient to increase the impact strength of the composition and which includes one or more ethylenic elastomers including copolymers of ethylene and at least one other monomer which includes one or more unsaturated organic acids or their derivatives, or one or more C₃ to C₂₀ alpha-olefins with an optional diene, and about 0.01 to 15 weight percent of a processability modifier component with the following characteristics: (a) a melt flow rate from about 0.001 to 4 dg/min, measured at 230° C. and 2.16 kg, and (b) a weight average molecular weight of about 150,000 to less than 800,000.

In one embodiment, the composition includes about 5 to 95 weight percent of the high flow, propylene-based resin and about 1 to 50 weight percent of an ethylene-based toughening component. In a preferred embodiment, the composition includes about 15 to 75 weight percent of the high flow, propylene-based resin, about 7 to 38 weight percent of the toughening component, and about 1 to 9 weight percent of the processability modifier component.

In one embodiment, the high flow, propylene-based resin has a weight average molecular weight that is less than that of the processability modifier component. In another embodiment, the high flow, propylene-based resin includes homopolymers of propylene, copolymers of at least about 50 weight percent propylene and at least one other C₂ to C₂₀ alpha-olefin, or mixtures thereof. In a preferred embodiment, the high flow, propylene-based resin includes a copolymer of at least about 70 weight percent propylene and a C₂ to C₂₀ alpha-olefin that includes ethylene, 1-butene, 1-pentene, 1-hexene, methyl-1-butene, methyl-1-pentene, 1-octene, 1-decene, or a combination thereof. In one preferred embodiment, the high flow, propylene-based resin has a melt flow rate of about 25 to 800 dg/min. In another preferred embodiment, the high flow, propylene-based resin has a crystallinity of at least about 30 percent.

In one embodiment, the ethylene-based toughening component includes one or more ethylenic elastomers including copolymers of ethylene with at least one other monomer chosen from C₃ to C₂₀ alpha-olefins, unsaturated organic acids and their derivatives, or terpolymers of ethylene, a C₃ to C₂₀ alpha-olefin, and a nonconjugated diene monomer, or combinations thereof. In yet another embodiment, the toughening component includes a copolymer of ethylene with at least one other C₃ to C₂₀ alpha-olefin monomer that includes propylene, octene, butene, hexene, or a combination thereof. In various preferred embodiments, the ethylene-based toughening component is substantially amorphous, has a Mooney viscosity of at least about 5, has a weight average molecular weight of at least about 100,000 to 700,000, or has a combination of these features. In another embodiment, the toughening component has a melt index of no more than about 5 dg/min and a density from about 0.80 to 0.91 g/cm³. In yet another embodiment, the toughening component includes copolymers that are linear, substantially linear, random, blocky, or branched, or a combination thereof and that are substantially free of crosslinking.

In another embodiment, the processability modifier component includes homopolymers of propylene, copolymers of at least about 70 weight percent propylene and at least one other C₂ to C₂₀ alpha-olefin, or mixtures thereof. In a preferred embodiment, the processability modifier component has a melt flow rate of greater than about 0.001 dg/min and less than about 1 dg/min, a weight average molecular weight (M,) of about 200,000 to 700,000, a density of about 0.85 to 0.936 g/cm³, or a combination of such features.

In one embodiment, the composition includes about I to 15 weight percent of a styrenic compatibilizer. In another embodiment, the composition further includes about 1 to 40 weight percent of at least one mineral filler.

The invention also encompasses a molded article including the compositions described above. In a preferred embodiment, the invention also encompasses an automotive component including the compositions discussed herein.

The invention also encompasses a method of minimizing or avoiding visible surface defects on a molded article which includes providing a thermoplastic elastomer composition including a high flow, propylene-based resin having a melt flow rate of at least about 20 dg/min, measured at 230° C. and 2.16 kg, present in an amount sufficient to increase a rigidity of the composition; an ethylene-based toughening component, with a weight average molecular weight of at least about 95,000, present in an amount sufficient to increase the impact strength of the composition; and about 0.01 to 15 weight percent of a processability modifier component with the following characteristics: (a) a melt flow rate from about 0.001 to 4 dg/min, measured at 230° C. and 2.16 kg; and (b) a weight average molecular weight of about 150,000 to less than 800,000, and molding the composition to obtain an article having a reduced amount of surface defects compared to conventional molded compositions.

### DETAILED DESCRIPTION OF THE PREFERRED EMBODIMENTS

In accordance with the present invention, it has now been found that the surface appearance of a molded part formed from a thermoplastic elastomeric blend containing a sufficient amount of at least one high flow propylene-based resin to increase the rigidity of the composition and a sufficient amount of at least one ethylene-based toughening component to increase the impact strength of the composition may be enhanced by the addition of at least one processability modifier component. The thermoplastic elastomeric blend containing the processability modifier component may be injection molded into a molded part with simple or even complex cavity geometries and increased flow length versus wall thickness ratios, while the molded part thus obtained is at least substantially free, and preferably entirely free, of visible surface defects such as flow marks or flow plumes.

The high flow propylene-based resin includes at least one semicrystalline polymer with a weight average molecular weight from about 100,000 to 900,000, preferably from 110,000 to less than 800,000, and more preferably from about 125,000 to 760,000. The propylene-based resin is typically chosen from one or more homopolymers of propylene, copolymers of at least 50 weight percent propylene and at least one other C₂ to C₂₀ alpha-olefin, or mixtures thereof. The high flow propylene-based resin is typically present in an amount sufficient to increase the rigidity of the inventive composition compared to a composition formed absent the high flow propylene-based resin. In preferred embodiments, the high flow propylene-based resin is present in amounts from about 5 to 95 weight percent, from about 10 to 80 weight percent, or from about 15 to 75 weight percent. “High flow” as defined herein means a melt flow rate (“MER,” as determined by ASTM D-1238-01 at a temperature of 230° C. and at a load of 2.16 kg) of about 20 to 1,000 dg/min, preferably about 25 to 800 dg/min, and more preferably about 45 to 750 dg/min. In one more preferred embodiment, the MFR is about 80 to 600 dg/min. “Semicrystalline,” as used herein, typically means that the crystallinity is at least about 30%, preferably at least about 50% and more preferably at least about 80%, with at least about 10%, preferably at least about 15%, being amorphous. The high flow, semicrystalline propylene-based resin may be isotactic or syndiotactic, with a stereoregularity of at least about 80%, preferably at least about 90%. The propylene-based resin may be grafted or ungrafted.

When the high flow, propylene-based resin includes copolymers of propylene, the copolymer can include a random or impact block copolymer. Preferred alpha-olefins for such copolymers include ethylene, 1-butene, 1-pentene, 1-hexene, methyl-1-butenes, methyl-1-pentenes, 1-octene, 1-decene, or combinations thereof. If any such copolymer or mixture is employed, it is preferable to use one having an alpha-olefin content of about 1 to 45 weight percent. In one embodiment, the alpha-olefin content can be about 10 to 30 weight percent.

The random copolymers of propylene and an alpha-olefin, when used, generally include macromolecular chains in which the monomers are distributed statistically. The propylene content of these random copolymers, although it can be as low as 50 or 60 percent, is generally preferred to be at least about 70 mole percent and more preferably at least about 75 mole percent.

The impact block copolymers may include distinct blocks of variable composition; each block including a homopolymer of propylene and at least one other of the above-mentioned alpha-olefins. Although any suitable copolymerization method is included within the scope of the invention, copolymers with propylene blocks are generally obtained by polymerization in a number of consecutive stages in which the different blocks are prepared successively, as described in U.S. Pat. No. 3,318,976, which is hereby incorporated by express reference thereto. The order in which the different block components are polymerized is generally not critical. The alpha-olefin block component, when present, is distinct and different from the ethylene-based toughening component present in the current invention. In typical processes of this kind, propylene homopolymer is formed in one stage and the copolymer is formed in a separate stage, in the presence of the homopolymer and of the original catalyst. Multiple stage processes of this type are also known, and either type can be used in accordance with the present invention.

For the catalyst for producing the impact block copolymer, it is preferred to employ a catalyst for producing a highly stereospecific polypropylene formed from:
(a) a solid catalyst component based on titanium containing magnesium, a halogen and an electron donor, such as Ziegler-Natta catalysts,
(b) a catalyst component based on organometallic compound(s), such as metallocene, constrained geometry, and late transition metal catalysts, and
(c) a catalyst component based on organosilisic compound(s) having at least one group selected from the group consisting of cyclopentyl, cyclopentenyl, cyclopentadienyl, and derivatives thereof.

The polymerization in each stage may be realized either continuously or in a batchwise or a semicontinuous process, though a continuous process is preferred. The polymerization may be performed by any suitable method, such as by known methods that include, for example, a gas phase polymerization or a liquid phase polymerization, such as solution polymerization, a slurry polymerization, or a bulk polymerization. The polymerizations in the second and the subsequent stages may preferably be carried out after to the first stage polymerization in a continuous manner. When a batch process is employed, the multistage polymerization can be effected in a single reactor. Products of such sequential polymerization processes may be referred to as “block copolymers,” but it should be understood that such products may also include intimate blends of polypropylene and propylene/alpha-olefin elastomer.

In a preferred embodiment, a semicrystalline propylene/alpha-olefin impact block copolymer with a melt flow rate of at least about 20 dg/min (230° C., 2.16 kg) may be a mixture of a block A1, with about 90 to 100 weight percent semicrystalline propylene and an alpha-olefin content of 0 to about 10 weight percent, and of a block A2, with about 20 to 80 weight percent of a semicrystalline propylene and an alpha-olefin content of about 20 to 80 weight percent. The semicrystalline propylene/alpha-olefin block copolymer may be produced by a two-step polymerization, such as by conducting the first polymerization step of producing the block A1 and the second polymerization step of producing the block A2. Alternatively, the semicrystalline propylene/alpha-olefin block copolymer may be produced by mechanically blending, in the molten or softened state, a propylene/alpha-olefin block copolymer with an alpha-olefin content of 0 to about 10 weight percent and a propylene/alpha-olefin random copolymer with an alpha-olefin content of about 20 to 80 weight percent.

Exemplary high flow, semicrystalline propylene homopolymers or copolymers with melt flow rates of at least about 20 dg/min are commercially available as, for example, PROFAX, ADFLEX or HIFAX from Basell North America, Inc. of Wilmington, Del., as FORTILENE, ACCTUFF, or ACCPRO from British Petroleum Chemicals of Houston, Tex., and as various types of polypropylene homopolymers and copolymers from ExxonMobil Chemicals Company of Houston, Tex., from Borealis A/S from Lydgby, Denmark, from Sunoco Chemicals of Pittsburgh, Pa., and from Dow Chemical Company of Midland, Mich.

The ethylene-based toughening component is preferably substantially amorphous. The ethylene-based toughening component is typically present in an amount sufficient to increase the impact strength of the inventive polymer composition compared to a composition formed absent the ethylene-based toughening component. Preferred amounts of the ethylene-based toughening component include, e.g., from about 1 to 50 weight percent, preferably about 3 to 40 weight percent, and more preferably about 7 to 38 weight percent of the composition of the current invention. The ethylene-based toughening component typically has a Mooney viscosity (ML 1+4, 121° C.), as measured by ASTM D-1646-00, of at least about 5, preferably of at least about 15 in certain embodiments. In one preferred mode, the ethylene-based toughening component has a Mooney viscosity of at least about 20.

The weight average molecular weight (M_{w}) of the ethylene-based toughening component is typically at least about 95,000, and preferably greater than about 100,000. In one embodiment, the M_{w} is greater than about 100,000 and no more than about 1,000,000, while in another embodiment the M_{w} is at least about 150,000 to about 700,000. The melt index of such high molecular weight elastomers can be difficult to measure, but may be less than about 5 dg/min, preferably less than about 1 dg/min. Melt index is inversely proportional to the molecular weight of the polymer. Thus, the higher the molecular weight, the lower the melt index, although the relationship is not linear. The density of the ethylene-based toughening component is preferably from about 0.80 to 0.91 g/cm³.

The ethylene-based toughening component of the present invention includes one or more ethylenic elastomers that each include copolymers of ethylene with at least one other-monomer chosen from C₃ to C₂₀ alpha-olefins, unsaturated organic acids and their derivatives, vinyl esters, vinylsilanes and unconjugated aliphatic and monocyclic diolefins, alicyclic diolefins that have an endocyclic bridge and conjugated aliphatic diolefins, or terpolymers of ethylene, a C₃ to C₂₀ alpha-olefin, a nonconjugated diene monomer, or combinations thereof.

In the case of ethylene/alpha-olefin copolymers, the alpha-olefin includes one or more C₃ to C₂₀ alpha-olefins, with propylene, octene, butene, and hexene being preferred, and octane and butene being more preferred for use in the substantially amorphous toughening component.

For elastomeric terpolymers, i.e., substantially amorphous elastomers with at least three comonomers, the alpha-olefin again can include one or more of C₃ to C₂₀ alpha-olefins with propylene, butene, and octene preferred and propylene being most preferred. These terpolymers typically include a diene component, which can include one or more of C₄ to C₂₀ dienes, preferably non-conjugated dienes. Examples of suitable dienes include straight chain, hydrocarbon di-olefin or cylcloalkenyl-substituted alkenes having from 6 to 15 carbon atoms. Specific preferred examples include one or more classes or species including: (a) straight chain acyclic dienes such as 1,4-hexadiene and 1,6-octadiene; (b) branched chain acyclic dienes such as 5-methyl-1,4-hexadiene; 3,7-dimethyl-1,6-octadiene; 3,7-dimethyl-1,7-octadiene; and the mixed isomers of dihydro-myricene and dihydro-ocinene; (c) single ring alicyclic dienes, such as 1,3 cyclopentadiene; 1,4-cyclohexadiene; 1,5-cyclooctadiene and 1,5-cyclododecadiene; (d) multi-ring alicyclic fused and bridged ring dienes such as tetrahydroindene; methyl-tetrahydroindene; dicyclopentadiene (DCPD); bicyclo-(2.2.1)-hepta-2,5-diene; alkenyl, alkylidene, cycloalkenyl and cycloalkylidene norbornene, such as 5-methylene-2-norbornene (MNB), 5-propenyl-2-norbornene, 5-isopropylidene-2-norbornene, 5-ethylidene-2-norbornene (ENB), 5-(4-cyclopentenyl)-2-norbornene, 5-cyclohexylidene-2-norbornene, and 5-vinyl-2-norbornene (VNB); (e) cycloalkenyl-substituted alkenes, such as allyl cyclohexene, vinyl cyclooctene, allyl cyclodecene, vinyl cyclododecene, or any combinations within any class or of any species. Of the non-conjugated dienes typically used, the preferred dienes include dicyclopentadiene, 1,4-hexadiene, 5-methylene-2-norbornene, and 5-ethylidene-2-norbornene, or combinations thereof. More preferred diolefins include 5-ethylidene-2-norbornene; 1,4-hexadiene, dicyclopentadiene, 5-vinyl-2-norbornene, and combinations thereof. As used herein, the terms “non-conjugated diene” and “diene” are used interchangeably.

The ethylene-based toughening component may be linear, substantially linear, random, blocky or branched, or a combination thereof. “Substantially amorphous,” as used herein, typically means that the elastomer has less than about 25 percent crystallinity, preferably less than about 20 percent crystallinity.

The ethylene-based toughening component and other polymeric components can individually or together be crosslinked (or vulcanized) or noncrosslinked (unvulcanized), as is well known to those of ordinary skill in the art. When desired, this is typically accomplished after blending or forming. In one embodiment, unvulcanized or noncrosslinked elastomers or polymeric components are preferably used in making blends of the invention, although this does not exclude embodiments where some minor amounts of crosslinking could be present or desired, e.g., the ethylene-based toughening component can be substantially free of crosslinking. For example, crosslinking can be present in amounts up to about 5 weight percent of the elastomeric materials, preferably in up to about 2 percent of the elastomeric materials. In one preferred embodiment, the unvulcanized elastomers or polymeric components do not contain any detectable crosslinking using conventional equipment. Optionally, the ethylene-based toughening component can be one or more thermoplastic vulcanizates (TPVs), or be any of the previously discussed materials combined with one or more TPVs.

Exemplary ethylene-based toughening components are commercially available as NORDEL or ENGAGE from DuPont Dow Elastomers LLC of Wilmington, Del., as VISTALON or EXACT from ExxonMobil Chemicals of Houston, Tex., as DUTRAL from Polimeri Europa Americas of Houston, Tex., as BUNA EP from Bayer Corporation of Pittsburgh, Pa., and as ROYALENE from Uniroyal Chemicals of Middlebury, Conn.

The processability modifier component generally has a melt flow rate of about 0.001 dg/min to 4 dg/min, preferably greater than 0.001 dg/min and less than 4 dg/min, more preferably less than about 1 dg/min. In a preferred embodiment, the processability modifier component is preferably less than about 0.5 dg/min. The processability modifier component is typically present in amounts from about 0.01 to 15 weight percent, preferably about 0.1 to 12 weight percent, and more preferably about 1 to 9 weight percent. The processability modifier component includes one or more homopolymers of propylene, copolymers of at least 70 weight percent propylene and at least one other C₂ to C₂₀ alpha-olefin, or mixtures thereof. In a preferred embodiment, the processability modifier component is a propylene homopolymer. More preferably, in this embodiment, the propylene homopolymer has a melt flow rate that is less than or equal to about 0.4 dg/min, with M_{w} of at least about 200,000, Mₙ no more than about 250,000, and polydispersity of about 2 to 7.

The weight average molecular weight (M_{w}) of the processability modifier component is typically from about 150,000 to 800,000, while the number average molecular weight (Mₙ) is typically from about 45,000 to 300,000. Preferably, the M_{w} of the processability modifier component is from about 175,000 to 750,000, more preferably from about 200,000 to 700,000. The density of the processability modifier component is generally from about 0.85 to 0.936 g/cm³, and preferably about 0.89 to 0.915 g/cm³, while the polydispersity is generally from about 1.8 to 10, preferably about 1.9 to 8, and more preferably about 2 to 7.

While any suitable process is acceptable for preparing the processability modifier component, it is preferably prepared separately from the high flow propylene-based resin and then added to a combination of the high flow propylene-based resin component and the ethylene-based toughening component during melt blending in a continuous or batch mechanical mixer as hereinafter described. Alternatively, a polymerization process for the high flow propylene-based resin may be carried out in at least two sequential steps, wherein the high flow propylene-based resin and the processability modifier component are prepared in separate subsequent steps, operating in each step, except the first step, in the presence of the polymer formed and the catalyst used in the preceding step as described in U.S. Pat. 4,420,592, which is hereby incorporated by express reference thereto. The catalyst is added only in the first step; however, its activity is such that it generally still retains activity for many or all of the subsequent steps. The catalyst may also be pre-contacted with a small amount of propylene in a prepolymerization step, using techniques and apparatus well known to those of ordinary skill in the art. The order in which the different components are polymerized is generally not critical. Thus, when using at least two polymerization steps, a high flow propylene-based resin having a melt flow rate greater than about 20 dg/min is polymerized in a reactor with a processability modifier component having a melt flow rate of less than about 4 dg/min. The polydispersity index (M_{w}/Mₙ) of the resultant polymer, as measured by gel permeation chromatography, is preferably from about 2.5 to 12.

Exemplary processability modifier components with melt flow rates less than about 4 dg/min are commercially available as, for example, PROFAX from Basell North America, Inc. of Wilmington, Del., as FORTILENE from British Petroleum Chemicals of Houston, Tex., and as various types of low melt flow rate polypropylene homopolymers from Sunoco Chemicals of Pittsburgh, Pa.

The thermoplastic elastomeric blend may optionally contain one or more saturated or unsaturated styrenic compatibilizers with up to about 50 mole percent styrene. “Styrenic compatibilizer,” as used herein, designates a compatibilizer having at least one styrenic block segment and an elastomeric block segment that can optionally, but preferably, be hydrogenated. When such optional styrenic compatibilizers are included, they can typically be present in amounts of about 1 to 15 weight percent.

Any structure of the styrenic block segment is acceptable, although generally it will be of the linear or radial type, and of the diblock, triblock, or branched type. The styrenic block segment is preferably a polymer of styrene and/or its analogs and homologs, including alpha-methylstyrene, and ring-substituted styrenes, particularly ring-methylated styrenes, or any combination thereof. The preferred styrenics are styrene and alpha-methylstyrene, with styrene being especially preferred.

The elastomeric block segment of the above styrenic compatibilizer may be ethylene, butylene, butadiene, isoprene, propylene, or a combination thereof. Preferred styrenic compatibilizers include styrene-ethylene/butylene, styrene-ethylene/butylene-styrene, styrene-ethylene/propylene, styrene-ethylene/propylene-styrene, styrene-ethylene/propylene-styrene-ethylene-propylene, styrene-butadiene, styrene-butadiene-styrene, styrene-butylene-styrene, styrene-butylene-butadiene-styrene, styrene-isoprene-styrene, or combinations thereof.

Exemplary styrenic compatibilizers are commercially available as TUFTEC from Asahi America Inc. of Malden, Mass., as SEPTON from Kuraray Company, Ltd. of Tokyo, Japan, as KRATON from Kraton Polymers of Houston, Tex., or as DYNARON from Japan Synthetic Resin of Tokyo, Japan.

A variety of conventional additives may also be optionally, but preferably, included in the compositions of the invention, including one or more thermal stabilizers, mineral fillers, ultraviolet stabilizers, antioxidants, foaming agents, waxes, crosslinking agents, flowability improving agents such as peroxides, nucleating agents, plasticizers, colorants, mold release agents, pigments, and the like, or combinations thereof, to vary the resultant properties of the compositions, blends, and articles of the invention.

Suitable mineral fillers include, but are not limited to, talc, ground calcium carbonate, precipitated calcium carbonate, precipitated silica, precipitated silicates, precipitated calcium silicates, pyrogenic silica, hydrated aluminum silicate, calcined aluminosilicate, clays, mica, wollastonite, and combinations thereof. When such optional mineral fillers are included, they can typically be present in amounts of about 1 to 40 weight percent, preferably in amounts of about 2 to 20 weight percent in one embodiment and in amounts of about 15 to 35 weight percent in an another embodiment.

Melt blending is one suitable method for preparing the final polymer blend of the present invention, although any suitable polymer blending techniques available to those of ordinary skill in the art may be used. Techniques for melt blending of a polymer with additives of all types are known to those of ordinary skill the art and can typically be used with the present invention. In one type of melt blending operation useful with the present invention, the individual components of the blend are combined in a mechanical extruder or mixer, and then heated to a temperature sufficient to form a polymer melt and effect the modification to reduce or avoid surface defects.

The mechanical mixer can be a continuous or batch mixer. Examples of suitable continuous mixers include single screw extruders, intermeshing co-rotating twin screw extruders such as Werner & Pfleiderer ZSK™ extruders, counter-rotating twin screw extruders such as those manufactured by Leistritz™, and reciprocating single screw kneaders such as Buss™ co-kneaders. Examples of suitable batch mixers are lateral 2-roll mixers such as Banbury™ or Boling™ mixers. The temperature of the melt, residence time of the melt within the mixer, and the mechanical design of the mixer are several well known variables that control the amount of shear to be applied to the composition during mixing, and can be readily selected by one of ordinary skill in the art based on the disclosure of the invention herein.

The thermoplastic blend of the current invention may be pelletized via strand pelleting or commercial underwater pelletization. Pellets of the present composition may then be used to manufacture articles in the desired shape or configuration by any of a number of means well known to those of ordinary skill in the art, such as various types of conventional molding procedures, extrusion procedures, or the like.

The articles formed from the composition of the current invention may be utilized in a wide field of applications, such as automotive parts, housings for various types of equipment, and the like, or any portion thereof. Such articles are preferably molded, although other suitable manufacturing techniques or combinations thereof may be used.

The term “substantially free,” as used herein in reference to defects, should be understood to mean that the outer surface of an article prepared with a composition, i.e., blend, of the invention has less than about 10 percent, preferably less than about 5 percent, and more preferably less than about 1 percent, of its surface area covered with visible defects. The term also includes the preferred embodiment, in which articles of the invention contain no visible surface defects. Most preferably, the outer surface of an article prepared with the present composition should be “entirely free” of defects, (i.e., there are no surface defects, whether visible or not.)

The term “about,” as used herein, should generally be understood to refer to both numbers in a range of numerals. Moreover, all numerical ranges herein should be understood to include each whole integer within the range.

### EXAMPLES

The invention is further defined by reference to the following examples, describing the preparation of some thermoplastic blends of the present invention. It will be apparent to those of ordinary skill in the art that many modifications, both to materials and methods, may be practiced without departing from the purpose and intent of this invention. Thus, the following examples are offered by way of illustration, and not by way of limitation, to describe in greater detail certain methods for the preparation, treatment, and testing of some thermoplastic blends of the invention.

Molded parts with complex geometry were prepared to test for surface defects such as flow marks or flow plumes. Complex geometries include articles having one or more features that are difficult to injection mold in an article that is substantially free of visible surface defects, e.g., thin walls (below about 5 mm), curved rims, flanges, ribs, and the like. The molding conditions followed included: barrel temperature at 250° C., mold temperature at 80° C., injection speed at 6.35 cm/sec, and injection pressure from 6.9 to 9.6 MPa. Also tested were various gating systems including, for example, multiple gates, sequentially filled valve gates, and cashew gates. Once molded, the part (a bumper fascia) was cut down into smaller sections for ease of handling, resulting in a part with dimensions of 25 cm×13 cm, with a wall thickness of 3.5 mm and containing at least one feature line. The molded part was then visually inspected for surface defects. The surface appearance of the part was ranked according to the following scale:

| | |
|---|---|
| 1 | Good - no visible surface defects (e.g., flow marks or |
| | flow plumes) on the upper surface of the molded part |
| 2 | Fair - surface defects cover 50% of the upper surface of |
| | the molded part |
| 3 | Poor - surface defects cover 100% of the upper surface |
| | of the molded part |

Additional test specimens were prepared by injection molding using a Van Dorn 120HT Injection Molding Machine at a melt temperature of 200° C. and a mold cavity temperature of 18° C. The significance of the symbols used in these examples, the units expressing the variables mentioned, and the methods of measuring these variables, are explained below.

| | |
|---|---|
| MFR [dg/min] | Melt Flow Rate, measured in dg/min at |
| | 230° C., under a load of 2.16 kg, according |
| | to ASTM D-1238-01 |
| AMMS [mils/in] | After (Injection) Molding Mold Shrinkage, |
| | measured as mils/in of dimensional stability |
| | after at least 40 hours of conditioning at |
| | 23° C., according to ASTM D-955-96 |
| Flexural modulus | Flexural Modulus, measured as mega-Pascals at |
| [MPa] | 23° C. and a test speed of 2 mm/min and a |
| | rectangular test specimen of dimensions |
| | 4 mm × 6 mm, according to ISO 178 (2001) |
| Impact resistance | Izod Pendulum Impact Resistance, measured as |
| [ft-lb/in] | ft-lb/in after at least 40 hours of conditioning |
| | at 23° C., with a test specimen of |
| | dimensions ⅛″ × ½″ × |
| | 2.5″ and a 45° notch, according to Test |
| | Method A of ASTM D-256-00 |

Materials used in the examples:

| | |
|---|---|
| PP-1 | Polypropylene copolymer; C₂ content: 4.3%; MFR: |
| | 82 dg/min at 230° C. and 2.16 kg weight |
| PP-2 | Polypropylene copolymer; C₂ content: 2.5%; MFR: |
| | 95 dg/min at 230° C. and 2.16 kg weight |
| PP-3 | Polypropylene copolymer; C₂ content: 2.5%; MFR: |
| | 78 dg/min at 230° C. and 2.16 kg weight |
| Processability | Polypropylene homopolymer; MFR: 0.27 dg/min at |
| Modifier Comp. | 230° C. and 2.16 kg weight; Mw = 479,333 |
| Toughening | Copolymer of ethylene and C₃ to C₂₀ alpha-olefin(s); |
| Component | C₂ content: 67.5%; MI: 0.4 dg/min at 190° C. and |
| | 2.16 kg weight |
| Compatibilizer | Styrenic elastomer; Styrene content: 18%; MI: 0.06 |
| | dg/min at 190° C. and 2.16 kg weight; Specific |
| | Gravity: 0.89 |
| Fillers | Talc, average particle size = 1.9 microns |
| Additives | Color concentrates, UV stabilizer packages, Mold |
| | release agents |

Table I illustrates that the physical properties of molded parts made of thermoplastic blends prepared according to the present invention were comparable to the physical properties of the comparative examples, indicating that the presence of the processability modifier component was not detrimental to the stiffness/impact balance. The surface appearance of the molded parts prepared according to the invention, however, showed a surprising and unexpected improvement in the reduction or avoidance of visible surface defects when even small quantities of the processability modifier component was added to the composition used to form the molded parts.

TABLE 1

| wt % | Ex. 1 | Ex. 2 | Ex. 3 | Comp. Ex. 1 | Comp. Ex. 2 | Comp. Ex. 3 |
|---|---|---|---|---|---|---|
| PP-1 | — | 55 | 55 | — | 60 | 60 |
| PP-2 | 55 | — | — | — | — | — |
| PP-3 | — | — | — | 59 | — | — |
| Toughening Comp. | 28 | 23 | 28 | 27 | 23 | 27 |
| Compatibilizer | — | 5 | — | — | 5 | — |
| Processability Modifier | 5 | 5 | 5 | — | — | — |
| Fillers | 8 | 8 | 8 | 10 | 8 | 8 |
| Additives | 4 | 4 | 4 | 4 | 4 | 5 |
| MFR [dg/min] | 18.9 | 16.7 | 16.8 | 26.8 | 25.5 | 27.8 |
| AMMS [mils/in] | 8.2 | 7.4 | 7.5 | 8.9 | 7.9 | 8.1 |
| Flexural modulus [MPa] | 1431 | 1397 | 1440 | 1488 | 1314 | 1343 |
| Impact resistance [ft-lb/in] | 2.4 | 4.1 | 2.3 | 1.9 | 2.9 | 2.4 |
| Surface appearance | 1 | 1 | 1 | 3 | 2 | 3 |

Although preferred embodiments of the invention have been described in the foregoing description, it will be understood that the invention is not limited to the specific embodiments disclosed herein but is capable of numerous modifications by one of ordinary skill in the art. It will be understood that the materials used and the chemical details may be slightly different or modified from the descriptions herein without departing from the methods and compositions disclosed and taught by the present invention.

1. A thermoplastic elastomeric composition comprising:
a high flow, propylene-based resin having a melt flow rate of at least about 20 dg/min, measured at 230° C. and 2.16 kg, present in an amount sufficient to increase a rigidity of the composition;
an ethylene-based toughening component, with a weight average molecular weight of at least about 95,000 to 1,000,000 which is present in an amount sufficient to increase the impact strength of the composition and which comprises one or more ethylenic elastomers including one or more copolymers of ethylene and at least one other monomer which comprises one or more unsaturated organic acids or their derivatives, or one or more C₃ to C₂₀ alpha-olefins with an optional diene; and
about 0.01 to 15 weight percent of a processability modifier component with the following characteristics:
(a) a melt flow rate from about 0.001 to 4 dg/min, measured at 230° C. and 2.16 kg; and
(b) a weight average molecular weight of about 150,000 to less than 800,000.

2. The composition of claim 1, which comprises about 5 to 95 weight percent of the high flow, propylene-based resin and about 1 to 50 weight percent of an ethylene-based toughening component.

3. The composition of claim 1, comprises about 15 to 75 weight percent of the high flow, propylene-based resin, about 7 to 38 weight percent of the ethylene-based toughening component, and about 1 to 9 weight percent of the processability modifier component.

4. The composition of claim 1, wherein the high flow, propylene-based resin has a weight average molecular weight that is less than that of the processability modifier component.

5. The composition of claim 1, wherein the high flow, propylene-based resin comprises homopolymers of propylene, copolymers of at least about 50 weight percent propylene and at least one other C₂ to C₂₀ alpha-olefin, or mixtures thereof.

6. The composition of claim 1, wherein the high flow, propylene-based resin comprises a copolymer of at least about 70 weight percent propylene and a C₂ to C₂₀ alpha-olefin that comprises ethylene, 1-butene, 1-pentene, 1-hexene, methyl-1-butene, methyl-1-pentene, 1-octene, 1-decene, or a combination thereof.

7. The composition of claim 1, wherein the high flow, propylene-based resin has a melt flow rate of about 25 to 800 dg/min.

8. The composition of claim 1, wherein the high flow, propylene-based resin has a crystallinity of at least about 30 percent.

9. The composition of claim 1, wherein the ethylene-based toughening component comprises:
one or more ethylenic elastomers including one or more copolymers of ethylene with at least one other monomer chosen from C₃ to C₂₀ alpha-olefins, unsaturated organic acids and their derivatives; or
terpolymers of ethylene, a C₃ to C₂₀ alpha-olefin, and a nonconjugated diene monomer, or combinations thereof.

10. The composition of claim 1, wherein the ethylene-based toughening component comprises a copolymer of ethylene with at least one other C₃ to C₂₀ alpha-olefin monomer that comprises propylene, octene, butene, hexene, or a combination thereof.

11. The composition of claim 1, wherein the ethylene-based toughening component is substantially amorphous, has a Mooney viscosity of at least about 5, and has a weight average molecular weight of at least about 100,000 to 700,000.

12. The composition of claim 1, wherein the ethylene-based toughening component has a melt index of no more than about 5 dg/min and a density from about 0.80 to 0.91 g/cm³.

13. The composition of claim 1, wherein the ethylene-based toughening component comprises copolymers that are linear, substantially linear, random, blocky, or branched, or a combination thereof and that are substantially free of crosslinking.

14. The composition of claim 1, wherein the processability modifier component comprises homopolymers of propylene, copolymers of at least about 70 weight percent propylene and at least one other C₂ to C₂₀ alpha-olefin, or mixtures thereof.

15. The composition of claim 1, wherein the processability modifier component has a melt flow rate of greater than about 0.001 dg/min and less than about 1 dg/min, a weight average molecular weight (M_{w}) of about 200,000 to 700,000, and a density of about 0.85 to 0.936 g/cm³.

16. The composition of claim 1, further comprising about 1 to 15 weight percent of a styrenic compatibilizer.

17. The composition of claim 1, further comprising about 1 to 40 weight percent of at least one mineral filler.

18. A molded article comprising the composition of claim 1.

19. An automotive component comprising the composition of claim 1.

20. A method of minimizing or avoiding visible surface defects on a molded article which comprises:
providing a thermoplastic elastomer composition comprising a high flow, propylene-based resin having a melt flow rate of at least about 20 dg/min, measured at 230° C. and 2.16 kg, present in an amount sufficient to increase a rigidity of the composition; an ethylene-based toughening component, with a weight average molecular weight of at least about 95,000, present in an amount sufficient to increase the impact strength of the composition; and about 0.01 to 15 weight percent of a processability modifier component with the following characteristics: (a) a melt flow rate from about 0.001 to 4 dg/min, measured at 230° C. and 2.16 kg; and (b) a weight average molecular weight of about 150,000 to less than 800,000; and
molding the composition to obtain an article having a reduced amount of surface defects compared to conventional molded compositions.
